(19) United States
(12) Patent Application Publication
(10) Pub. No.: US 2008/0197775 A1
(43) Pub. Date: Aug. 21, 2008

(54) Dielectric Barrier Discharge Lamp Configured as a Double Tube

(75) Inventors: Markus Roth, Landau (DE); Reinhold Wittkotter, Wipperfurth (DE)

Correspondence Address: OSRAM SYLVANIA INC, 100 ENDICOTT STREET, DANVERS, MA, 01923, US

(73) Assignee: Patent Treuhand Gesellschaft Fur Elektrische Gluhlampen MBH, Munchen (DE)

(21) Appl. No.: 11/884,264

(22) PCT Filed: Feb. 6, 2006
(86) PCT No.: PCT/DE06/00181

§ 371 Date: Aug. 14, 2007

(30) Foreign Application Priority Data
Feb. 14, 2005 (DE) 10 2005 006 656.9

(51) Int. Cl. H01J 11/00

(52) U.S. Cl. 313/607

(57) ABSTRACT

The invention relates to a dielectric barrier discharge lamp (1) of coaxial double tube configuration. Arranged inside the inner tube (3) is an inner electrode (6) that is designed in the form of a flexible, electrically conductive brush. The brush-type electrode (6) can be produced relatively easily and can be introduced effectively into the inner tube (3) because of the flexibility.

### TECHNICAL FIELD

The invention proceeds from a dielectric barrier discharge lamp having a discharge vessel in a coaxial double tube arrangement, that is to say an inner tube is arranged coaxially inside an outer tube. In this arrangement, the inner tube and outer tube are connected to one another at their two end faces, and thus form the gastight discharge vessel. The discharge space enclosed by the discharge vessel thus extends between the inner and outer tube.

This type of discharge lamp typically has a first electrode that is arranged inside the inner tube, and a second electrode that is arranged on the outside of the outer tube. The two electrodes are thus located outside the discharge vessel. In this case, then, there is a discharge that is dielectrically impeded at both ends. When, for the sake of simplicity, there is occasion to speak below of the inner electrode or inside electrode and the outer electrode or outside electrode, this designation consequently relates only to the spatial arrangement of the relevant electrode with reference to the coaxial double tube arrangement, that is to say inside the inner tube or on the outside of the outer tube.

This type of lamp is applied, in particular, for UV irradiation in process engineering, for example for surface cleaning and activation, photolysis, ozone generation, drinking water purification, metallization and UV curing. In this context, the designation of radiator or UV radiator is also customary.

The coaxial arrangement of two tubes, for example made from silica glass, permits the construction of lamps with very large lengths. Long lamps are important for high powers, since the maximum power that can be coupled into the lamp increases with the length. However, the fitting of the inner electrode causes problems in the case of long lamps, for example longer than 1 m, as well as in the case of lamps with a small inner tube diameter. On the one hand, the inner electrode is to bear firmly against the wall of the inner tube, that is to say without sagging, and on the other hand it is to be as easy to mount as possible. These problems become even more acute when the discharge vessel is arcuate, for example U-shaped.

### PRIOR ART

DE 196 13 502 A1 describes a generic dielectric barrier discharge lamp. What is involved here is an excimer radiator with a closed discharge space that is designed as an annular gap between two silica glass tubes arranged coaxially with one another. The discharge space contains a filling gas that forms excimers under discharge conditions. An outer electrode in the form of a grid is provided on the outside of the wall of the outer silica glass tube, while the inner electrode is formed by a wire spiral bearing against the inside of the wall of the inner silica glass tube. Because of the relatively large distance to the adjacent electrode, the regions of high field strength are concentrated on a spatially small region, and a high field strength gradient occurs on the radiator surface. Filaments can thereby form more easily in the region of the wire spiral. Upon application of a high voltage between electrodes, so-called excimers are formed in the filling gas of the discharge space and, depending on chemical composition, output noncoherent UV radiation that is, however, substantially monochromatic. However, the inner electrode in the form of the wire spiral cannot be mounted very easily in the case of the known excimer radiator.

The generation of radiation can be fashioned more efficiently by suitable selection of the electric mode of operation, as described in document EP 733 266 B1, in conjunction with suitable electrode arrangements. Upon application of negative high voltage at the inner conductor (cathode side) Δ-like discharge structures are formed whose apex lies on the cathode side. This substantially diffusely shining discharge is achieved by applying a closed electrode surface in the inner conductor.

Document EP 767 484 A1 discloses an embodiment of a dielectric barrier discharge lamp in the case of which the inner electrode is designed in the form of a metal tube with a longitudinal slot running in the direction of the radiator axis. In order to mount the inner electrode, the slotted metal tube is rolled up a little and then inserted into the inner tube. This causes the inner electrode to bear firmly against the wall of the inner tube such that the numerous discharge filaments formed in the discharge space are substantially homogeneously distributed. However, the filaments tend to migrate along the longitudinal slot when the lamp axis is oriented vertically.

In document DE 198 56 428, a metal strip is installed in the shape of a spiral as inner electrode. This has the advantage that the filaments are distributed homogeneously and are fixed in space even given a vertical installation. The fact that it is still not very simple to produce the inner electrode is a disadvantage. However, even with the metal strip spiral, limited regions appear where the discharges take place virtually exclusively.

Another possibility is to apply a conductive coating in the interior of the inner tube. This method, too, is very expensive, since long drying and baking times are required.

### SUMMARY OF THE INVENTION

The object of the present invention is to specify a dielectric barrier discharge lamp in a coaxial double tube arrangement with an improved inner electrode.

This object is achieved by means of a dielectric barrier discharge lamp having
a discharge vessel that
   has an outer tube and a inner tube,
   the inner tube being arranged inside the outer tube, and
   the inner tube and the outer tube being connected to one another in a gastight fashion, as a result of which a discharge space filled with a discharge medium is formed between the inner and outer tubes, and
a first electrode and at least one further electrode,
   the first electrode being arranged inside the inner tube
characterized in that

the first electrode is designed in the form of an electrically conductive brush.

Particularly advantageous refinements are to be found in the dependent claims.

Starting from the dielectric barrier discharge described at the beginning, according to the invention the inner electrode is designed in the form of a conductive brush that, for example, is formed by weaving thin metal filaments, the braid wires or bristles, into two intertwisted metal wires, also called twisted wires. In this case, the twisted wires run in an axial direction, and the braid wires in the bristle tufts run radially in the direction of the inner wall of the inner tube and touch the inner tube with the tips. Alternatively, the braid wires can also be inserted radially into an elongated axial carrier. In any event, a very dense and uniform covering of the inner surface of the radiator with individual electrodes is achieved with the aid of the inventive conductive brush as inner electrode. The homogeneous discharge structure is maintained because of the multiplicity of possible discharge points. Moreover, however, there is also the advantage of the slight local field increase, which reduces the starting or operating voltage.

In a preferred refinement, the inner electrode is designed as a round brush. The round brush electrode can consist, for example, of fine filaments made from conductive material (bristles) that are woven into two or more spirally wound carrier wires (twisted wires). At least one of the twisted wires is electrically conductive. The bristles are aligned substantially perpendicular to the twisted wires and are entwined spirally around the twisted wires in bristle tufts. The outside diameter of the round brush is a little larger in this case than the inside diameter of the inner tube in order to ensure reliable contact. The large outside diameter of the brush in the stress-relieved state compared with the inside diameter of the inner tube, ensures that the bristles or fine metal wires preferably come to bear not only with their tips. The diameter in the stress-relieved state is to be found when the brush is not installed. Here, the outer diameter is understood as the maximum diameter of the cross section perpendicular to the longitudinal axis of the brush. The effect of the undesirably excessive local field strength increases is also reduced by the slight bearing of the bristles mentioned above. This spiral shape of the inner electrode prevents undesired migration of the discharge filaments very effectively, specifically independently of the spatial orientation of the discharge lamp. The preferably elastic deformability of the round brush facilitates the mounting in the inner tube. Moreover, the inner electrode thus formed is also suitable for arcuate inner tubes.

The spacing of the bristles within a bristle tuft in the stress-relieved state is advantageously 0.01 mm to 1 mm. The discharge is the more homogeneous the smaller the gap selected between the neighboring bristles, that is to say with increasing density of the bristles. However, as the bristle spacing becomes tighter there is a decrease in the deformability of the brush, and this renders mounting more difficult. The spacing is preferably between 0.05 mm and 0.2 mm.

Bristles with a diameter between 0.005 mm and 0.5 mm, preferably between 0.02 mm and 0.2 mm, have proved particularly effective.

Twisted wires with thicknesses between 0.2 mm and 2 mm have proved to be advantageous with regard to their elastic deformability.

Stainless steel is preferably suitable as material both for the twisted wires and for the bristles.

The inner electrode designed according to the invention in the form of a brush is particularly well suited for discharge lamps with an arcuate inner tube. Because of its flexibility, the inner electrode according to the invention can adapt to the bend of the inner tube. The bend can be embodied both as a kink and as a continuous curve. A circular, semicircular, banana-shaped or U-shaped curvature of the inner tube may be mentioned by way of example.

The inner electrode according to the invention combines ease of mounting with uniform covering of the inner surface of the inner tube, and consequently with a homogeneous discharge inside the discharge vessel. It is, moreover, easy to produce.

The at least one further electrode is typically arranged on the outside of the outer tube. Both grid-type and strip-shaped and/or linear electrodes, inter alia come into consideration as outer electrode. A reflector, preferably made from aluminum, that can simultaneously function as ground electrode can be provided for the purpose of directional emission on the rear side of the lamp according to the invention, that is to say on the side opposite to the side provided for the light emission. Alternatively, the lamp according to the invention can be embedded in a metal block, for example made from aluminum, including a number of lamps next to one another. In this variant, the metal block functions as outer electrode, preferably at ground potential. It is possible in addition to connect a cooling system.

### BRIEF DESCRIPTION OF THE DRAWINGS

The aim below is to explain the invention in more detail with the aid of exemplary embodiments. In the figures:

FIG. 1a shows a side view of a discharge lamp according to the invention with an inner electrode in the form of a round brush,

FIG. 1b shows a cross sectional illustration of the exemplary embodiment from FIG. 1a,

FIG. 2 shows a side view of a discharge lamp according to the invention with a segment inner electrode,

FIG. 3a shows a side view of a discharge lamp according to the invention with an inner electrode in the form of a half round brush,

FIG. 3b shows a cross sectional illustration of the exemplary embodiment from FIG. 3a, and

FIG. 4 shows a side view of a U-shaped discharge lamp according to the invention with an inner electrode in the form of a round brush.

### PREFERRED EMBODIMENT OF THE INVENTION

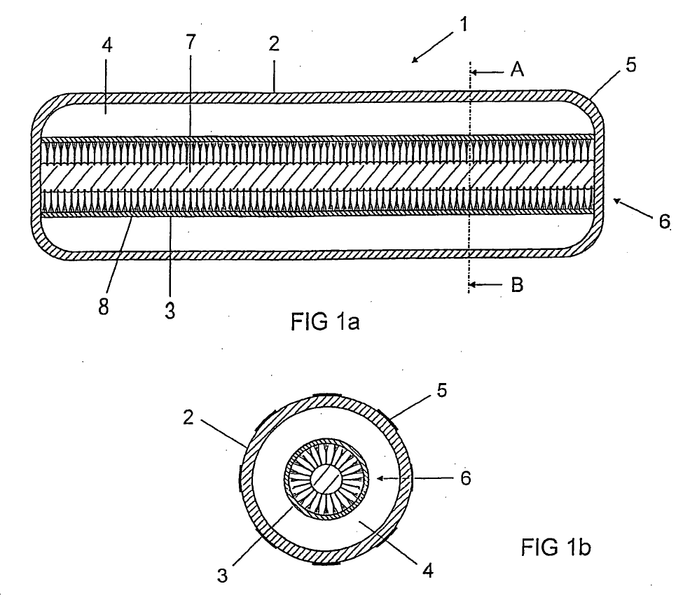

FIGS. 1a, 1b show in a highly schematic illustration a side view and a cross-sectional illustration, respectively, of a first exemplary embodiment of the dielectric barrier discharge lamp 1 according to the invention. The elongated discharge vessel of the lamp 1 consists of an outer tube 2 and an inner tube 3 in a coaxial double tube arrangement that thus defines the longitudinal axis of the discharge vessel. The length of the dielectric barrier discharge lamp 1 designed for an electric power consumption of 20 W is 20 cm. The outer tube 2 has a diameter of 40 mm and a wall thickness of 1 mm. The inner tube 3 has a diameter of 11 mm and a wall thickness of 1.2 mm. The two tubes 2, 3 consist of silica glass transparent to UV radiation. Moreover, the discharge vessel is sealed at its two end faces in such a way as to form an elongated discharge space 4 in the shape of an annular gap. To this end, the discharge vessel respectively has at its two ends suitably shaped vessel sections 5 of annular type. Moreover, there is applied to one of the vessel sections 5 an exhaust tube (not illustrated) with the aid of which the discharge space 4 is firstly evacuated and subsequently filled with 15 kPa of xenon. In total eight uniformly distributed, linear outer electrodes 5 of width 1 mm are arranged parallel to the longitudinal axis of the discharge vessel on the outside of the wall of the outer tube 2. An inner electrode 6 in the form of a round brush is arranged in the interior of the inner tube 3, that is to say likewise outside the discharge space 4 enclosed by the discharge vessel. The inner electrode comprises an axial carrier element 7 (illustrated here only in a simplified fashion) and numerous bristles 8. The carrier element 7 is formed from two intertwined stainless steel wires (twisted wires), diameter in each case 1 mm (not illustrated). Numerous stainless steel wires, diameter respectively 0.06 mm, which are oriented radially relative to the carrier element 7 and function as bristles 8 are woven in, in tuftwise fashion, to the two twisted wires of the carrier element 7 in the shape of a spiral along the entire length of the carrier element 7.

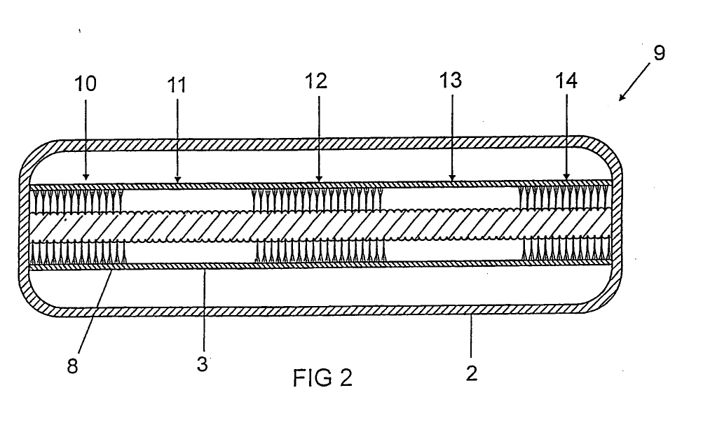

FIG. 2 shows a further exemplary embodiment, identical features as in FIGS. 1a, 1b being provided with identical reference numerals. The dielectric barrier discharge lamp 9 illustrated schematically there differs from the lamp illustrated in FIGS. 1a, 1b only in that here the inner electrode is subdivided into five segments 10-14. The carrier element 7 is provided within the segments 10, 12 and 14 over the entire circumference with radially running bristles 8. These segments 10, 12 and 14 alternate with the segments 11 and 13 in which there are no bristles. Consequently, during operation the lamp 9 preferably radiates in subregions of the segments 10, 12 and 14, whereas no discharge forms in segments 11 and 13.

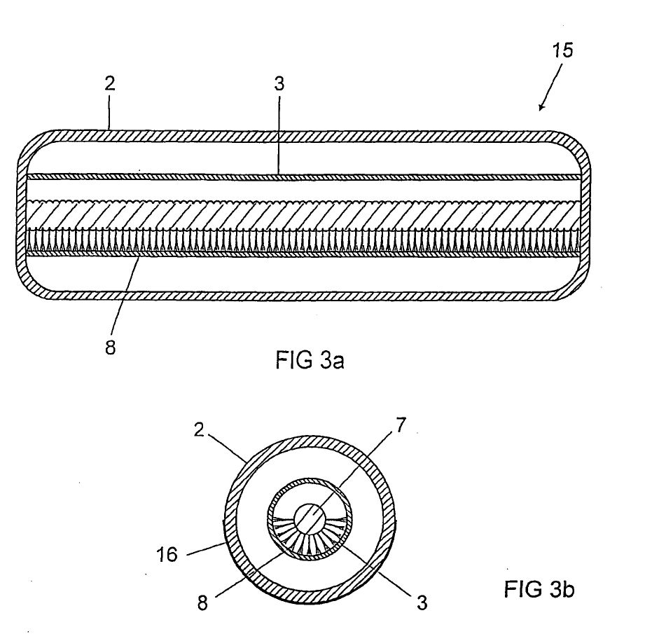

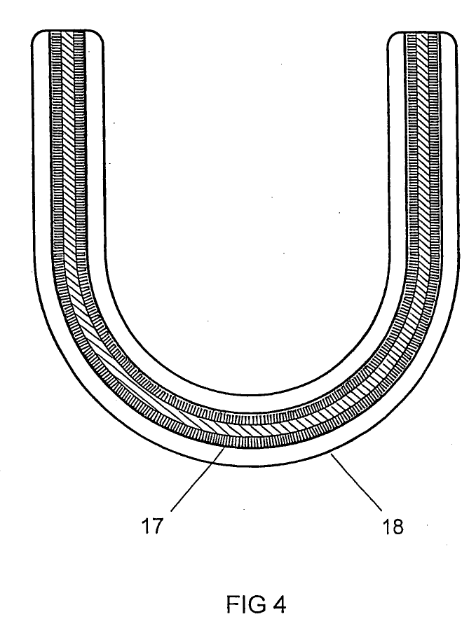

FIGS. 3a, 3b show a highly schematic illustration of a side view and, respectively, a cross sectional illustration of a further exemplary embodiment. Here, as well, identical features as in FIGS. 1a, 1b are provided with identical reference numerals. The dielectric barrier discharge lamp 9 illustrated schematically there differs from the lamp illustrated in FIGS. 1a, 1b in that here the inner electrode is provided with radial bristles 8 only in a semicylindrical fashion. Moreover, the outside of the wall of the outer tube 2 is provided in the form of a half shell with an outer electrode 16 made from aluminum that extends along the entire length of the outer tube 2. In this arrangement, the outer electrode 16 is oriented such that it is directly opposite the inner electrode in the form of a half-round brush. This effects a preferred direction for the emission. The outer electrode 16 can be, for example, vapor deposited, glued on or plugged on. Moreover, the outer electrode can also be formed by a metal block in which the lamp is partially embedded.

FIG. 5 illustrates schematically an exemplary embodiment in which the discharge vessel and consequently the inner tube 17 and the outer tube 18 are bent in a U-shaped fashion. The flexible inner electrode 6 according to the invention is capable of following this bend without any problem. Again, the inner electrode 6 can be inserted into the inner tube in a fashion relatively free from problems because of the flexibility both of the carrier element and of the bristles.

1. A dielectric barrier discharge lamp (1) having
a discharge vessel that
has an outer tube (2) and a inner tube (3),
the inner tube (3) being arranged inside the outer tube (2), and
the inner tube (3) and the outer tube (2) being connected to one another in a gastight fashion, as a result of which a discharge space (4) filled with a discharge medium is formed between the inner and outer tubes, and
a first electrode (6) and at least one further electrode (5),
the first electrode (6) being arranged inside the inner tube (3)
characterized in that
the first electrode (6) is designed in the form of an electrically conductive brush.

2. The dielectric barrier discharge lamp as claimed in claim 1, in which the first electrode (6), in the form of a brush, has an elongated carrier element (7) and bristles (8) that are arranged substantially radially thereto and extend substantially up to the wall of the inner tube (3).

3. The dielectric barrier discharge lamp as claimed in claim 1, in which the carrier element (7) and the bristles (8) consist of a flexible material.

4. The dielectric barrier discharge lamp as claimed in claim 3, in which the flexible material is metal, preferably stainless steel.

5. The dielectric barrier discharge lamp as claimed in claim 1, in which the carrier element (7) is provided with bristles at least in sections for the entire circumference, in the manner of a round brush.

6. The dielectric barrier discharge lamp as claimed in claim 5, in which the diameter of the electrode (6) of the type of a round brush is greater in the dismantled state than the inside diameter of the inner tube (3) of the discharge vessel.

7. The dielectric barrier discharge lamp as claimed in claim 1, in which each bristle (8) consists of one wire.

8. The dielectric barrier discharge lamp as claimed in claim 7, in which the diameter of the bristle wire is from 0.005 mm to 0.5 mm, preferably from 0.02 mm to 0.2 mm.

9. The dielectric barrier discharge lamp as claimed in claim 7, in which in the dismantled state the mutual average spacing of the bristle wires of the brush-type electrode is from 0.01 mm to 1 mm, preferably from 0.05 mm to 0.2 mm.

10. The dielectric barrier discharge lamp as claimed in claim 1, in which the carrier element consists of at least two intertwisted wires.

11. The dielectric barrier discharge lamp as claimed in claim 10, in which the diameter of each twisted wire is 0.2 mm to 2 mm.

12. The dielectric barrier discharge lamp as claimed in one of the preceding claims claim 1, in which the at least one further electrode (5) is arranged on the outside of the outer tube (2).

13. The dielectric barrier discharge lamp as claimed in claim 12, in which the at least one further electrode (5) is of grid type, or strip-shaped or linear.

14. The dielectric barrier discharge lamp as claimed in claim 1, that is embedded at least partially in a metal block that functions as a further electrode.

15. The dielectric barrier discharge lamp as claimed in claim 1, in which the discharge tube is arcuate.

16. The dielectric barrier discharge lamp as claimed in claim 2, in which the carrier element (7) and the bristles (8) consist of a flexible material.

17. The dielectric barrier discharge lamp as claimed in claim 16, in which the flexible material is metal, preferably stainless steel.

18. The dielectric barrier discharge lamp as claimed in claim 2, in which the at least one further electrode (5) is arranged on the outside of the outer tube (2).

19. The dielectric barrier discharge lamp as claimed in claim 2, in which the carrier element (7) is provided with bristles at least in sections for the entire circumference, in the manner of a round brush.

20. The dielectric barrier discharge lamp as claimed in claim 2, in which each bristle (8) consists of one wire.
